(19) United States
(12) Patent Application Publication
(10) Pub. No.: US 2026/0342938 A1
(43) Pub. Date: Oct. 29, 2026

(54) ELECTRONIC APPARATUS AND CONTROL METHOD

(71) Applicant: CANON KABUSHIKI KAISHA, Tokyo (JP)

(72) Inventors: TAKAMICHI KOSUGI, Tokyo (JP); IPPEI UCHIDA, Tokyo (JP)

(21) Appl. No.: 19/690,740

(22) Filed: May 28, 2026

Related U.S. Application Data
(63) Continuation of application No. PCT/JP2024/039122, filed on Nov. 1, 2024.

(30) Foreign Application Priority Data
Dec. 7, 2023 (JP) 2023-207171

(51) Int. Cl. H04N 7/10

(52) U.S. Cl. CPC H04N 7/104

(57) ABSTRACT

An electronic apparatus includes a common terminal connected to an external apparatus, a plurality of signal processing units connected to the common terminal, at least one first switch that switches the common terminal and at least one signal processing unit to one of a connected state and a non-connected state, and a control unit that controls operation states of the plurality of signal processing units and an open/closed state of the first switch. The plurality of signal processing units include a first signal processing unit that is connected to the common terminal without via the first switch and processes a first signal, and at least one signal processing unit that is connected to the common terminal via the first switch and processes a signal with a transmission rate lower than a transmission rate of the first signal.

### CROSS-REFERENCE TO RELATED APPLICATIONS

This application is a Continuation of International Patent Application No. PCT/JP2024/039122, filed November 1, 2024, which claims the benefit of Japanese Patent Application No. 2023-207171, filed December 7, 2023, both of which are hereby incorporated by reference herein in their entirety.

### BACKGROUND

### FIELD OF THE TECHNOLOGY

The present disclosure relates to a technique of sharing terminals with different signaling systems.

### DESCRIPTION OF THE RELATED ART

An electronic apparatus such as a digital video camera is mounted with a plurality of terminals (interfaces) adaptive to various signaling systems (signal standards), such as terminals for serially or parallelly inputting/outputting analog signals or digital signals. Since these terminals have dedicated shapes, the types and number of terminals mounted on the electronic apparatus influence the size of a housing forming the outer shape of the electronic apparatus.

Since it is desired to downsize the electronic apparatus, there is provided a technique of sharing a plurality of terminals to reduce the housing size. Japanese Patent No. 4182672 discloses a configuration in which a plurality of signal processing units are connected in parallel to a common terminal and are switched by a switch circuit. Japanese Patent Laid-Open No. 2012-239011 discloses a configuration in which a path from a common terminal to a signal processing unit is switched by a plurality of switch elements.

According to Japanese Patent No. 4182672, an input signal of the common terminal passes through the switch circuit, and thus may deteriorate. Japanese Patent Laid-Open No. 2012-239011 does not consider sharing a low-speed transmission signal terminal and a high-speed transmission signal terminal.

### SUMMARY

The present disclosure has been made in consideration of the aforementioned problems, and provides technical advantages in sharing terminals with different signaling systems while reducing deterioration of a high-speed transmission signal.

In order to solve the aforementioned problems, the present disclosure is directed to an electronic apparatus comprising: a common terminal connected to an external apparatus; a plurality of signal processing units connected to the common terminal; at least one first switch that switches the common terminal and at least one signal processing unit among the plurality of signal processing units to one of a connected state and a non-connected state; and a control unit that controls operation states of the plurality of signal processing units and an open/closed state of the first switch, wherein the plurality of signal processing units include a first signal processing unit that is connected to the common terminal without via the first switch and processes a first signal, and at least one signal processing unit that is connected to the common terminal via the first switch and processes a signal with a transmission rate lower than a transmission rate of the first signal, and the control unit sets the first switch in the non-connected state in a state in which the first signal processing unit processes the first signal.

Features of the present disclosure will become apparent from the following description of embodiments with reference to the attached drawings.

### BRIEF DESCRIPTION OF THE DRAWINGS

FIG. 1 is a block diagram exemplifying the configuration of an electronic apparatus according to a first embodiment;

FIG. 2 is a block diagram exemplifying the configuration of an electronic apparatus according to a second embodiment; and

FIG. 3 is a block diagram exemplifying the configuration of an electronic apparatus according to a third embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

This embodiment will describe an example in which an electronic apparatus is an image capture apparatus such as a digital video camera that captures a video such as a moving image. However, the present disclosure is not limited to the image capture apparatus, and may be applied to video equipment that records, reproduces, or edits a video, and the like.

### First Embodiment

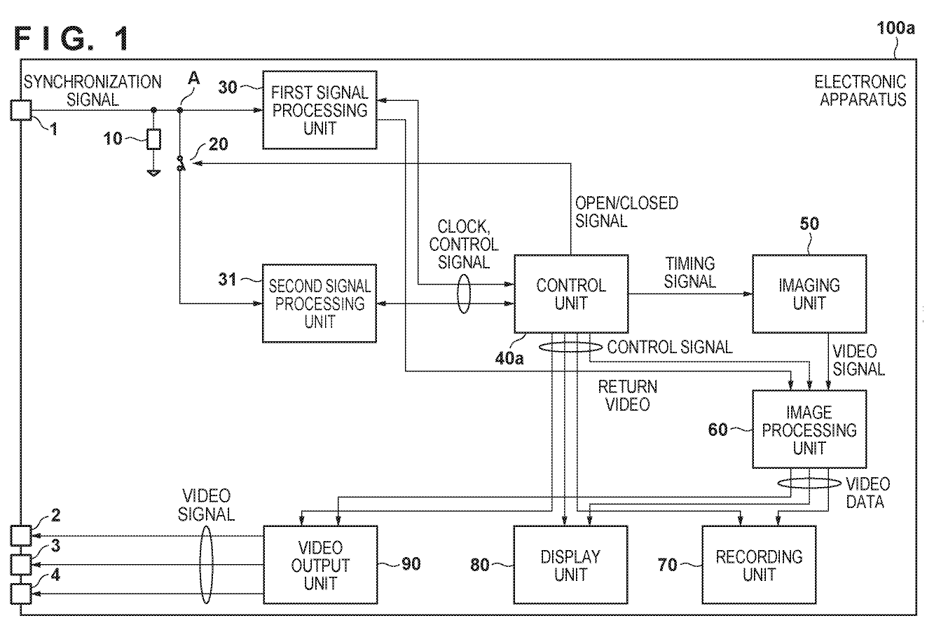

The configuration and function of an electronic apparatus according to a first embodiment will be described first with reference to FIG. 1.

An electronic apparatus 100a is provided with one common terminal 1 and a plurality (in FIG. 1, three) of external output terminals 2, 3, and 4. The common terminal 1 and the external output terminals 2, 3, and 4 are provided in a housing forming the outer shape of the electronic apparatus 100a, and are each connected to a signal processing circuit via a signal transmission line in the electronic apparatus 100a.

The common terminal 1 is formed by sharing input terminals of signals using different signaling systems (signal standards) such as analog, digital, serial, and parallel signaling systems and having different transmission rates or frequency bands, which are input from external apparatuses.

Each of the external output terminals 2, 3, and 4 is connected to a video input terminal of an external apparatus via a cable or the like, and outputs a video signal to the external apparatus.

The external apparatus is an image capture apparatus that captures a video such as a moving image, video equipment that records, reproduces, or edits a video, or the like.

The electronic apparatus 100a includes a control unit 40a, an imaging unit 50, an image processing unit 60, a recording unit 70, a display unit 80, and a video output unit 90.

The control unit 40a includes a microcomputer, an ASIC (Application Specific Integrated Circuit), and an FPGA (Field Programmable Gate Array) for controlling the whole electronic apparatus 100a. The microcomputer includes a processor (CPU or MPU) that performs arithmetic processing and control processing of the electronic apparatus 100a, a volatile memory (ROM) that stores a program to be executed by the processor, and a work memory (RAM) into which a program read out from a nonvolatile memory and constants, variables, and the like for executing the program are loaded. The control unit 40a controls the respective components of the electronic apparatus 100a by loading the program stored in the ROM into the RAM and executing it.

The imaging unit 50 includes an image sensor formed by a CCD or CMOS sensor that converts a subject image into an electrical signal, and an A/D converter that converts an analog video signal output from the image sensor into a digital signal. The imaging unit 50 performs an image capture operation including reset of each pixel of the image sensor based on a timing signal of the control unit 40a, signal accumulation (exposure), and readout of a signal, and performs noise reduction processing and the like on an analog video signal for each generated frame, thereby outputting a digital video signal.

The image processing unit 60 performs digital signal processing on a video signal output from the imaging unit 50. The digital signal processing includes DeBayer processing, development processing, gamma processing, and encoding processing. Video data generated by the image processing unit 60 is output to the display unit 80 and the video output unit 90, and is stored in the recording unit 70 as a moving image file such as an H.264/MPEG-4 file. The image processing unit 60 is formed by a GPU (Graphics Processing Unit), an ASIC, an FPGA, or the like.

The recording unit 70 is a memory card, a hard disk, an SSD (Solid State Drive), or the like that stores a moving image file generated by the image processing unit 60.

The display unit 80 includes a display device such as a liquid crystal display or an organic EL display that displays a live view image, a reproduced video, a GUI (Graphical User Interface) for making various settings of the electronic apparatus 100a, and the like. A touch panel for accepting a user operation is integrally formed with the display unit 80, thereby making it possible to detect a touch operation by the user on the GUI. The various settings of the electronic apparatus 100a include, for example, setting at the time of image capturing, setting at the time of recording, setting at the time of display, setting at the time of outputting a video, and setting of a function assigned to the common terminal 1. The setting of the function assigned to the common terminal 1 is setting (external synchronization setting) at the time of synchronization with the external apparatus, and includes setting of inputting or outputting an analog signal and setting of inputting or outputting a digital signal. The control unit 40a changes the setting of the electronic apparatus 100a or controls the operation of the electronic apparatus 100a in accordance with a user operation via the touch panel. Note that the electronic apparatus 100a may include an operation unit such as a press button, a rotating dial, or a slide switch for accepting a user operation other than a user operation on the touch panel.

The video output unit 90 converts moving image data output from the image processing unit 60 into a video signal in a form complying with a predetermined standard, and outputs the video signal to the external apparatus via the external output terminal 2, 3, or 4. The video output unit 90 is formed by an ASIC, an FPGA, or the like, and may be formed on the same IC chip as the control unit 40a and the image processing unit 60. The external output terminals 2, 3, and 4 are, for example, a connector for outputting a video signal complying with HDMI^{®} (High-Definition Multimedia Interface) and two coaxial connectors each for outputting a video signal complying with SDI (Serial Digital Interface). As the coaxial connector, a 12G-SDI BNC connector with a 75-Ω impedance supporting 12 Gbps as a transmission rate of a video signal or a 3G-SDI BNC connector with a 75-Ω impedance supporting 3 Gbps is used.

The common terminal 1 is connected to and shared by a first signal processing unit 30 and a second signal processing unit 31. The first signal processing unit 30 is connected to the common terminal 1 without via a first switch 20, and the second signal processing unit 31 is connected to the common terminal 1 via the first switch 20. The first signal processing unit 30 and the second signal processing unit 31 process signals using different signaling systems (signal standards) and having different transmission rates or frequency bands. The second signal processing unit 31 processes a signal with a narrow frequency band and a low transmission rate or frequency, as compared with a signal processed by the first signal processing unit 30.

The common terminal 1 is a coaxial connector to which a synchronization signal is input from the external apparatus. For example, a BNC connector with a 75-Ω impedance or a DIN1.0/2.3 connector is used. The synchronization signal is transmitted through a 75-Ω transmission line, and is terminated by a termination 10 formed by a 75-Ω termination resistance arranged between the transmission line and GND to reduce deterioration of the signal caused by reflection noise. A video camera may be synchronized with the external apparatus by an analog signal or a digital signal. In a case where the video camera is synchronized by an analog signal, an analog synchronization signal such as a Black Burst signal or a tri-level synchronization signal is used. In a case where the video camera is synchronized by a digital signal, a digital synchronization signal such as an SD-SDI (Standard Definition-SDI) signal, an HD-SDI (High Definition-SDI) signal, or a 3G-SDI signal is used. The SDI signal is a video signal corresponding to a return video as a video captured by another image capture apparatus.

Since the analog synchronization signal and the digital synchronization signal are signals using different signaling systems (signal standards) and having different transmission rates or frequency bands, signal processing circuits adaptive to these signals are required.

With respect to the digital synchronization signal, the synchronization signal is input to the first signal processing unit 30. The first signal processing unit 30 performs equalizer processing of the SDI signal, detection of a horizontal synchronization signal H or a vertical synchronization signal V, and generation of a clock signal for synchronizing the control unit 40a with the external apparatus. The first signal processing unit 30 is formed by an equalizer IC for equalizer processing, an ASIC or FPGA for detection of the horizontal synchronization signal H or the vertical synchronization signal V, a PLL (Phase Locked Loop) for generation of the clock signal, and the like. The ASIC or FPGA may be formed on the same IC chip as the control unit 40a or the image processing unit 60. Note that the return video input from the external apparatus to the first signal processing unit 30 via the common terminal 1 can be displayed on the display unit 80 via the image processing unit 60 after performing equalizer processing, and can also be output to the external apparatus via the video output unit 90 and the external output terminal 2, 3, or 4.

With respect to the analog synchronization signal, the synchronization signal is input to the second signal processing unit 31 via the first switch 20. The second signal processing unit 31 performs detection of the horizontal synchronization signal H or the vertical synchronization signal V and generation of a clock signal for synchronizing the control unit 40a with the external apparatus. The second signal processing unit 31 is formed by a sync separator circuit and an ASIC or FPGA for detection of the horizontal synchronization signal H or the vertical synchronization signal V, a PLL for generation of the clock signal, and the like. Note that instead of the sync separator circuit and the ASIC or FPGA, a dedicated sync separator IC may be used. The ASIC or FPGA may be formed on the same IC chip as the control unit 40a, the image processing unit 60, and the first signal processing unit 30.

The clock signal generated by the first signal processing unit 30 or the second signal processing unit 31 is input to the control unit 40a. The control unit 40a synchronizes the image capture operation of the imaging unit 50 with the external apparatus based on the clock signal input from the first signal processing unit 30 or the second signal processing unit 31. The control unit 40a controls power down of the first signal processing unit 30 and the second signal processing unit 31, and the like in accordance with the external synchronization setting of the electronic apparatus 100a.

With respect to the SD-SDI signal, the HD-SDI signal, and the 3G-SDI signal, the physical layer specifications are defined in SMPTE (the Society of Motion Picture and Television Engineers) 259M, SMPTE 292M, and SMPTE 424M, respectively. The specifications includes a return loss (reflection loss) as one item, and 15 dB or more (5 MHz to 1.485 GHz) or 10 dB or more (1.485 to 2.97 GHz) is required for the 3G-SDI signal. To satisfy this requirement, it is necessary to match the impedance between the common terminal 1 and the signal processing unit 30 or 31. In this embodiment, however, since the transmission line branches to the first signal processing unit 30 and the second signal processing unit 31 at a position A in FIG. 1, an impedance mismatch occurs.

To cope with this, in this embodiment, in order to reduce the influence of signal reflection of the second signal processing unit 31 when the SDI signal is input from the common terminal 1, the first switch 20 is switched to an open state to disconnect the second signal processing unit 31 from the common terminal 1. Thus, the impedance of the first switch 20 seen from the common terminal 1 is high impedance, thereby making it possible to reduce the impedance mismatch at the branch point A of the transmission line from the common terminal 1 to the first signal processing unit 30. Furthermore, since there is no switch in the transmission line from the common terminal 1 to the first signal processing unit 30, no impedance mismatch occurs due to passage of a signal through a switch circuit.

Note that to further reduce the impedance mismatch, the first switch 20 may be arranged near the branch point A so that a stub length is minimized or the first switch 20 may be arranged on a surface opposite to the transmission line from the common terminal 1 to the first signal processing unit 30. In addition, the first switch 20 desirably has an input capacitance that is sufficiently small with respect to the frequency of a signal input from the common terminal 1.

The control unit 40a controls the operation states of the first signal processing unit 30 and the second signal processing unit 31 and the open/closed state of the first switch 20 in accordance with the external synchronization setting of the electronic apparatus 100a. When the external synchronization setting is the setting of inputting the digital synchronization signal, the control unit 40a sets a state in which the first signal processing unit 30 processes the input signal, and switches the first switch 20 to the closed state. When the external synchronization setting is the setting of inputting the analog synchronization signal, the control unit 40a sets a state in which the second signal processing unit 31 processes the input signal, and switches the first switch 20 to the closed state.

Note that the signal processing unit may automatically determine the type of the synchronization signal input from the common terminal 1, and control the open/closed state of the first switch 20 in accordance with the determination result. In this case, the synchronization signal is time-divisionally input to the first signal processing unit 30 and the second signal processing unit 31 by changing the open/closed state of the first switch 20, thereby controlling the open/closed state of the first switch 20 so that the synchronization signal is input to the signal processing unit corresponding to the determination result. In this case, the first signal processing unit or the second signal processing unit 31 controls the open/closed state of the first switch 20. Alternatively, by using a cable detection function mounted on the equalizer IC of the first signal processing unit 30, the first switch 20 may be set in the open state when detecting the synchronization signal by the equalizer IC. In this case, the first signal processing unit controls the open/closed state of the first switch 20. In addition, the type of the synchronization signal may be determined by analyzing the amplitude voltage, frequency, and other signal characteristics of the synchronization signal, thereby controlling the open/closed state of the first switch 20.

Note that the two signal processing units are provided in the example shown in FIG. 1, but three or more signal processing units may be provided. In this case, no switch is arranged in the transmission line of the signal processing unit with the highest signal transmission rate or frequency and strict required specifications of an impedance match, and a switch is arranged in the transmission line of another signal processing unit. Furthermore, in the example shown in FIG. 1, only the second signal processing unit 31 is provided at the subsequent stage of the first switch 20, but a plurality of signal processing units may be provided. In this case, to isolate the plurality of signal processing units, a switch may further be provided between the first switch 20 and the signal processing unit. In this case as well, the arrangement of the switches is determined in accordance with the required specifications of an impedance match and the signal transmission rate or frequency. Note that the control unit 40a controls the open/closed states of the switches.

This embodiment has explained an example in which the common terminal 1 is formed by sharing terminals of signals that are synchronization signals with the external apparatuses, use different signaling systems (signal standards), and have different transmission rates or frequency bands, but is not limited to the synchronization signals.

As described above, according to the first embodiment, the common terminal 1 and the plurality of signal processing units 30 and 31 are connected via the transmission lines and a switch for switching the common terminal 1 and each signal processing unit to a connected state or a non-connected state in accordance with the required specifications of an impedance match is provided. This can share terminals with different signaling systems while reducing deterioration of a high-speed transmission signal, thereby downsizing the electronic apparatus 100a.

### Second Embodiment

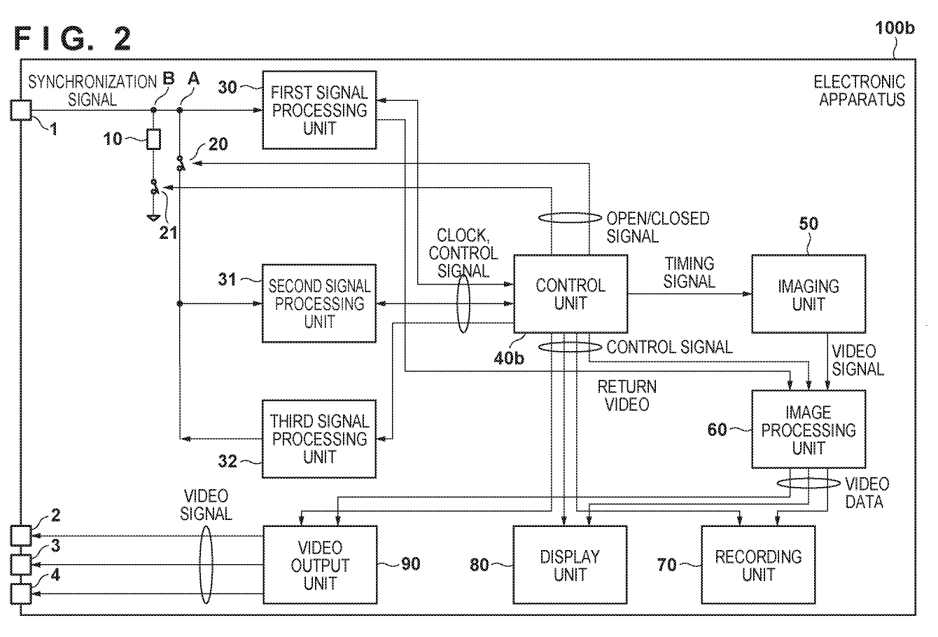

The configuration and function of an electronic apparatus according to a second embodiment will be described next with reference to FIG. 2.

In FIG. 2, in the configuration and function of an electronic apparatus 100b according to the second embodiment, the same reference numerals as in the first embodiment denote common parts.

The electronic apparatus 100b of the second embodiment is the same as the electronic apparatus 100a of the first embodiment except for control processing of a control unit 40b and a second switch 21 and a third signal processing unit 32 that are added.

In the second embodiment, a common terminal 1 is formed by sharing input/output terminals of signals using different signaling systems (signal standards) such as analog, digital, serial, and parallel signaling systems and having different transmission rates or frequency bands, which are input/output to/from external apparatuses.

The control unit 40b outputs, to the third signal processing unit 32, a clock signal synchronized with an image capture operation of an imaging unit 50. The third signal processing unit 32 generates a synchronization signal synchronized with the image capture operation of the imaging unit 50 based on the synchronization clock signal from the control unit 40b, and outputs the generated signal to the external apparatus via the common terminal 1. The control unit 40b controls power down of a first signal processing unit 30, a second signal processing unit 31, and the third signal processing unit 32 in accordance with the external synchronization setting of the electronic apparatus 100b.

The third signal processing unit 32 is formed by an ASIC or FPGA for generating a synchronization signal, a video driver for outputting the synchronization signal to the external apparatus, and the like. The video driver may be discretely formed using a transistor or an operational amplifier, or a dedicated video driver IC may be used.

Since each of the signal processing units 30 and 31 of the first embodiment is a circuit that processes a signal input from the common terminal 1, the 75-Ω termination 10 for an impedance match is required. However, in a case where the input signal terminal and the output signal terminal are shared as in the second embodiment, the 75-Ω termination 10 is unnecessary when outputting the signal from the common terminal 1.

In this embodiment, the second switch 21 is arranged between the termination 10 and GND, and is switched to the open state when outputting the signal from the common terminal 1. This separates the termination 10 from the transmission line from the third signal processing unit 32 as the signal output circuit to the common terminal 1.

The control unit 40b controls the open/closed state of the second switch 21 in accordance with the external synchronization setting of the electronic apparatus 100b. The control unit 40b switches the second switch 21 to the closed state in a case where the external synchronization setting is the setting of inputting a signal, and switches the second switch 21 to the open state in a case where the external synchronization setting is the setting of outputting a signal.

Furthermore, the control unit 40b switches a first switch 20 to the closed state in a case where the external synchronization setting is the setting of inputting an analog synchronization signal or the setting of outputting a signal, and switches the first switch 20 to the open state in a case where the external synchronization setting is the setting of inputting a digital synchronization signal. In a case where the external synchronization setting is the setting of outputting a signal, the control unit 40b sets a state in which the third signal processing unit 32 processes the output signal, and switches the first switch 20 to the closed state.

Note that to further reduce an impedance mismatch, the termination 10 and the second switch 21 may be arranged near a branch point B so that a stub length at the branch point B with the termination 10 is minimized, or the termination 10 and the second switch 21 may be arranged on a surface opposite to the transmission line from the common terminal 1 to the first signal processing unit 30. The arrangement of the termination 10 and the second switch 21 may be reversed so that the stub length at the branch point B is minimized. In addition, the second switch 21 desirably has an input capacitance that is sufficiently small with respect to the frequency of a signal input from the common terminal 1.

This embodiment has explained an example in which the common terminal 1 is formed by sharing terminals of signals that are synchronization signals with the external apparatuses, use different signaling systems (signal standards), and have different transmission rates or frequency bands, but is not limited to the synchronization signals.

As described above, according to the second embodiment, in addition to the effect of the first embodiment, the termination 10 of the transmission line connecting the common terminal 1 and the third signal processing unit 32 is switched to the connected state or the non-connected state by the switch depending on whether the signal is input to the common terminal 1 or output from the common terminal 1. This can share terminals with different signaling systems while reducing deterioration of a high-speed transmission signal, thereby downsizing the electronic apparatus 100b.

### Third Embodiment

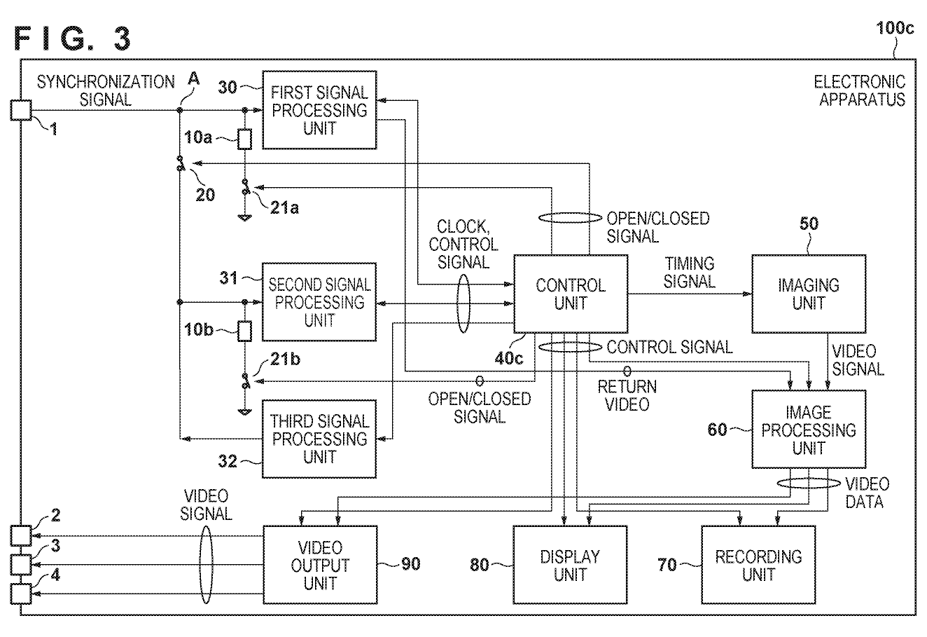

The configuration and function of an electronic apparatus according to a third embodiment will be described next with reference to FIG. 3.

In FIG. 3, in the configuration and function of an electronic apparatus 100c according to the third embodiment, the same reference numerals as in the first embodiment denote common parts.

The electronic apparatus 100c of the third embodiment is the same as the electronic apparatus 100a of the first embodiment except for control processing of a control unit 40c and a first termination 10a, a second termination 10b, a third switch 21a, a fourth switch 21b, and a third signal processing unit 32 that are added.

The terminations 10a and 10b are arranged near a first signal processing unit 30 and a second signal processing unit 31, respectively, to secure signal quality with respect to the electronic apparatus 100a of the first embodiment.

In the third embodiment, a common terminal 1 is formed by sharing input/output terminals of signals using different signaling systems (signal standards) such as analog, digital, serial, and parallel signaling systems and having different transmission rates or frequency bands, which are input/output to/from external apparatuses.

When it is determined that the setting of the common terminal 1 is changed by a user operation, the control unit 40c switches the third switch 21a and the fourth switch 21b to the closed state to connect the common terminal 1 to the first signal processing unit 30 and the second signal processing unit 31. This can decrease the signal amplitude value of the transmission line of the common terminal 1. In this embodiment, in a case where the combined resistance value of the first termination 10a and the second termination 10b is obtained and, for example, the termination resistances are 75 Ω, the combined resistance value on the termination side is 75/2 = 37.5 Ω, and the signal amplitude value is about 67% of the normal 75-Ω circuit.

Next, after a predetermined time elapses, the control unit 40c switches, to the closed state, switches other than the switch for implementing the function set by the user. For example, in the setting of using the first signal processing unit 30, the fourth switch 21b is switched to the closed state. In the setting of using the third signal processing unit 32, the third switch 21a and the fourth switch 21b are switched to the closed state. Note that in this embodiment, it is unnecessary to perform control limited to the time during which the processing is performed after the predetermined time elapses, and the processing may be performed after determining that the signal amplitude value is smaller than a predetermined value. For example, if each of the first signal processing unit 30, the second signal processing unit 31, and the third signal processing unit 32 can detect the signal amplitude value, determination may be performed by each signal processing unit, or a circuit configuration for determining the signal amplitude value may be added. If a circuit configuration is added, it is arranged in the signal processing unit (on the side of the signal processing unit 31 or 32 of a first switch 20) of a frequency lower than the signal frequency of the first signal processing unit 30, thereby making it possible to secure signal quality.

Furthermore, as control to switch, to the closed state, switches other than the switch for implementing the function set by the user in a case where there are provided a plurality of signal processing units, a plurality of terminations, and a plurality of switches as in the third embodiment, it is possible to control the third switch 21a and the fourth switch 21b so as to increase the combined resistance value of the terminations stepwise. In this case, a combination of the plurality of terminations and the plurality of switches is stored in advance, and the control unit 40c calculates the combined resistance value, and controls the open/closed states of the switches.

Furthermore, in this case, it is possible to set the second termination 10b in the non-connected state by the first switch 20. In the example shown in FIG. 3, the second termination 10b provided at the subsequent stage of the first switch 20 can be brought into the same state as in a case where the fourth switch 21b is set in the closed state, as viewed from the common terminal 1, by setting the first switch 20 in the non-connected state.

Furthermore, when the control unit 40c determines that there is no input signal even though the setting of the common terminal 1 is changed to the input setting, the third switch 21a and the fourth switch 21b are temporarily set in the open state, and the control sequence of the third embodiment is redone, thereby making it possible to avoid a circuit failure of the electronic apparatus 100c.

As described above, according to the third embodiment, in a case where the plurality of terminations 10a and 10b are arranged near the plurality of signal processing units 30 and 31 to secure signal quality, it is possible to suppress a signal amplitude value by controlling the open/closed states of the plurality of terminations 10a and 10b by the third switch 21a and the fourth switch 21b when the setting of the common terminal 1 is changed, thereby preventing a circuit failure of the electronic apparatus.

According to the present disclosure, it is possible to share terminals with different signaling systems while reducing deterioration of a high-speed transmission signal.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An electronic apparatus comprising:
a common terminal connected to an external apparatus;
a plurality of signal processing units connected to the common terminal;
at least one first switch that switches the common terminal and at least one signal processing unit among the plurality of signal processing units to one of a connected state and a non-connected state; and
a control unit that controls operation states of the plurality of signal processing units and an open/closed state of the first switch,
wherein the plurality of signal processing units include a first signal processing unit that is connected to the common terminal without via the first switch and processes a first signal, and at least one signal processing unit that is connected to the common terminal via the first switch and processes a signal with a transmission rate lower than a transmission rate of the first signal, and
the control unit sets the first switch in the non-connected state in a state in which the first signal processing unit processes the first signal.

2. The electronic apparatus according to claim 1, further comprising:
a setting unit that sets a function assigned to the common terminal,
wherein the control unit controls states of the plurality of signal processing units to one of a first state of processing a signal and a second state of not processing a signal in accordance with the function assigned to the common terminal.

3. The electronic apparatus according to claim 2, wherein
the plurality of signal processing units include a second signal processing unit that processes a signal with a frequency lower than a frequency of the first signal,
the frequency of the first signal is higher than a frequency of a second signal processed by the second signal processing unit, and
the first switch switches the second signal processing unit and the common terminal to one of the connected state and the non-connected state.

4. The electronic apparatus according to claim 3, wherein
the control unit sets the first signal processing unit in the first state and the second signal processing unit in the second state in accordance with input of the first signal to the common terminal, and sets the first signal processing unit in the second state and the second signal processing unit in the first state in accordance with input of the second signal to the common terminal.

5. The electronic apparatus according to claim 3, wherein
the control unit sets the first switch in the non-connected state in a case where the first signal processing unit is in the first state.

6. The electronic apparatus according to claim 1, further comprising:
a termination that terminates a signal input to the common terminal.

7. The electronic apparatus according to claim 3, wherein
the plurality of signal processing units include a third signal processing unit that is connected to the common terminal via the first switch and outputs a signal to the common terminal.

8. The electronic apparatus according to claim 7, wherein
the control unit sets the first switch in the connected state in a case where the third signal processing unit is in the first state and the first signal processing unit and the second signal processing unit are in the second state.

9. The electronic apparatus according to claim 7, further comprising:
a termination that terminates a signal input to the common terminal; and
a second switch that switches the termination and GND to one of the connected state and the non-connected state,
wherein in a case where a signal is input from the common terminal, the second switch is set in the connected state, and
in a case where a signal is output from the common terminal, the second switch is set in the non-connected state.

10. The electronic apparatus according to claim 9, wherein
the control unit switches the second switch to one of the connected state and the non-connected state in accordance with the function assigned to the common terminal.

11. The electronic apparatus according to claim 3, further comprising:
a first termination that is provided, at a subsequent stage of a position where the common terminal branches to the first signal processing unit and the second signal processing unit, between the position and the first signal processing unit, and terminates a signal input to the common terminal;
a second termination that is provided between the second signal processing unit and the first switch at a subsequent stage of the position, and terminates a signal input to the common terminal;
a third switch that switches the first termination and GND to one of the connected state and the non-connected state; and
a fourth switch that switches the second termination and GND to one of the connected state and the non-connected state.

12. The electronic apparatus according to claim 11, wherein
the control unit sets the third switch and the fourth switch in the connected state in a case where the function assigned to the common terminal is changed, and switches, to a closed state, a switch other than a switch for implementing the function assigned to the common terminal after a predetermined time elapses.

13. The electronic apparatus according to claim 11, wherein
the control unit sets the third switch and the fourth switch in the connected state in a case where the function assigned to the common terminal is changed, and then switches, to a closed state, a switch other than a switch for implementing the function assigned to the common terminal in a case where a signal amplitude value of the common terminal is smaller than a predetermined value.

14. The electronic apparatus according to claim 11, wherein
the control unit switches the second termination and GND to one of the connected state and the non-connected state by setting the first switch in the non-connected state in a case where the fourth switch is in the connected state.

15. The electronic apparatus according to claim 13, wherein
in a state in which the function assigned to the common terminal is setting of inputting a signal, in a case where it is determined that no signal is input, the control unit sets the third switch and the fourth switch in the non-connected state, and redoes control in a case where the function assigned to the common terminal is changed.

16. A control method of an electronic apparatus, wherein
the electronic apparatus comprises
a common terminal connected to an external apparatus,
a plurality of signal processing units connected to the common terminal, and
at least one first switch that switches the common terminal and at least one signal processing unit among the plurality of signal processing units to one of a connected state and a non-connected state,
the plurality of signal processing units include a first signal processing unit that is connected to the common terminal without via the first switch and processes a first signal, and at least one signal processing unit that is connected to the common terminal via the first switch and processes a signal with a transmission rate lower than a transmission rate of the first signal, and
the control method comprises
controlling operation states of the plurality of signal processing units and an open/closed state of the first switch, and
setting the first switch in the non-connected state in a state in which the first signal processing unit processes the first signal.

17. A non-transitory computer-readable storage medium storing a program for causing a computer to function as an electronic apparatus comprising:
a common terminal connected to an external apparatus;
a plurality of signal processing units connected to the common terminal;
at least one first switch that switches the common terminal and at least one signal processing unit among the plurality of signal processing units to one of a connected state and a non-connected state; and
a control unit that controls operation states of the plurality of signal processing units and an open/closed state of the first switch,
wherein the plurality of signal processing units include a first signal processing unit that is connected to the common terminal without via the first switch and processes a first signal, and at least one signal processing unit that is connected to the common terminal via the first switch and processes a signal with a transmission rate lower than a transmission rate of the first signal, and
the control unit sets the first switch in the non-connected state in a state in which the first signal processing unit processes the first signal.
